(19) United States
(12) Patent Application Publication
(10) Pub. No.: US 2021/0359543 A1
(43) Pub. Date: Nov. 18, 2021

(54) CONTROL OF OFF-GRID ENERGY SYSTEMS

(71) Applicant: Fenix International, Inc. a/k/a Fenix International Energy Services, San Francisco, CA (US)

(72) Inventors: Farhan Naeem, Hayward, CA (US); Abhijit Bhattacharya, Chatsworth, CA (US); Emma Frederick, San Francisco, CA (US); Arthur Sfez, Berkeley, CA (US); Andrew Timmins, Austin, TX (US)

(73) Assignee: Fenix International, Inc. a/k/a Fenix International Energy Services, San Francisco, CA (US)

(21) Appl. No.: 17/298,410

(22) PCT Filed: Mar. 17, 2020
(86) PCT No.: PCT/US20/23189

§ 371 Date: May 28, 2021

Related U.S. Application Data
(60) Provisional application No. 62/856,210, filed on Jun. 3, 2019.

(51) Int. Cl. H02J 13/00; G07F 9/00; G07F 15/00; G06Q 50/06; H02J 3/38

(52) U.S. Cl. CPC H02J 13/00022; G07F 9/001; H02J 3/381; G06Q 50/06; G07F 15/003

(57) ABSTRACT

A method for controlling an off-grid energy system. The off-grid energy system includes a gateway energy device and an expansion energy device. The gateway energy device comprising a gateway energy device, the gateway energy device comprising a first energy source, a first battery for storing energy from the first energy source, a first power output for outputting energy from the first battery, a first output lock for controlling the first power output, and a first radiofrequency (RF) transceiver. The expansion energy device comprising a second energy source, a second battery for storing energy from the second energy source, a second power output for outputting energy from the second battery, a second output lock for controlling the second power output, and a second RF transceiver for communicating with the first RF transceiver of the gateway energy device. The method includes the following steps: receiving a financial account status of the system from a financial account server; locking or unlocking the first power output of the gateway energy device responsive to the received financial account status; connecting with the at least one expansion energy device; sending instructions to operate or lock the at least one expansion energy device based on the received financial account status of the system; locking or unlocking the second power output of the at least one expansion energy device responsive to the received financial account status; and conserving power by limiting communications with the at least one expansion energy device during certain periods.

### CROSS-REFERENCE TO RELATED APPLICATION(S)

This application claims the benefit of and priority to U.S. Provisional Patent Application Ser. No. 62/856,210, filed Jun. 3, 2019 and entitled “WIRELESS CONTROL OF MULTIPLE OFF-GRID ENERGY SYSTEMS AND APPLIANCES THROUGH A SINGLE FINANCIAL GATEWAY,” the entirety of which is incorporated herein by reference.

### BACKGROUND

This application relates to the financing and control of off-grid energy systems and their associated appliances in developing countries. Approximately one billion people lack access to grid electricity. Most of this population lives in rural areas of developing countries, operating at the base of the economic pyramid. Centralized power generation and distribution through the electricity grid is slow to reach these populations due to the high capital cost and low investment returns of such projects. Standalone off-grid energy systems are a proven solution for bringing basic electricity to places where the grid does not reach. In these systems, a solar panel or other small-scale generating source is used to generate electricity. Electrical energy is stored in a battery and then used to power critical functions such as home lighting, charging of digital devices, and powering of larger appliances such as televisions and refrigerators.

The primary barrier to adoption of off-grid energy systems in rural markets has been the high upfront cost of the system. In recent years, the growing availability of mobile phones in rural markets coupled with mobile digital payment systems has helped lower this barrier. “Mobile money” systems provide rural customers with the ability to make recurring payments using their mobile phone, without having to travel to urban centers. Off-grid energy providers have leveraged this payment flexibility to offer flexible financing terms that are better aligned to the constrained cash flows of low-income households. To properly incentivize payment, manufacturers of off-grid energy systems integrate electronic lock-out technology into off-grid energy systems. If a customer fails to make a payment within a defined time interval, the energy system or appliance will automatically disable itself. Once a customer makes a payment through mobile money, an unlock signal is sent to the device through cellular networks or provides customers with an unlock code which a user can enter into the device manually.

To effectively serve the needs of the off-grid market, off-grid energy systems must be expandable. Expandable systems allow households to increase their level of energy service over time. This is especially important in “lease-to-own” financing arrangements. As customers build equity in an initial energy system, they often want to purchase an expansion to their energy system or additional appliances through the same financing mechanism while they are still servicing their original financial contract. Traditionally, customers who choose to expand their system have been forced to select one of two options. The first option is to replace their existing off-grid energy system with the newer, larger system. This forces obsolescence of the original system well before the end of its usable life. Alternatively, customers keep both their original off-grid system and the new, expansion system, forcing the customer to manage multiple loan accounts and unlock codes for multiple devices, even though all the accounts originate from the same creditor. Furthermore, this method of expansion requires replication of the same payment and lockout interface in each individual energy system, adding unnecessary cost and electricity consumption. While this structure is highly inefficient, it remains the state-of-the-art in bringing expandable energy systems to low-income, off-grid households.

### SUMMARY

In one embodiment, a method for controlling an off-grid energy system control is presented. The off-grid energy system includes a gateway energy device and an expansion energy device. The gateway energy device comprising a first energy source, a first battery for storing energy from the first energy source, a first power output for outputting energy from the first battery, a first output lock for controlling the first power output, and a first radio frequency (RF) transceiver. The expansion energy device includes a second energy source, a second battery for storing energy from the second energy source, a second power output for outputting energy from the second battery, a second output lock for controlling the second power output, and a second RF transceiver for communicating with the first RF transceiver of the gateway energy device. The method includes the following steps: receiving a financial account status of the system from a financial account server; locking or unlocking the first power output of the gateway energy device responsive to the received financial account status; connecting with the at least one expansion energy device; sending instructions to operate or lock the at least one expansion energy device based on the received financial account status of the system; locking or unlocking the second power output of the at least one expansion energy device responsive to the received financial account status; and conserving power by limiting communications with the at least one expansion energy device during certain periods. In one example, the gateway energy device may also include a means for receiving accounting status through a cellular signal or through a manual input.

In one embodiment, presented herein is an off-grid energy system. The system includes a gateway energy device and at least one expansion energy device. The off-grid energy system includes a gateway energy device and an expansion energy device. The expansion energy device includes a second energy source, a second battery for storing energy from the second energy source, a second power output for outputting energy from the second battery, a second output lock for controlling the second power output, and a second RF transceiver for communicating with the first RF transceiver of the gateway energy device. The gateway energy device is configured to receive a financial account status of the system from a financial account server. The expansion energy device includes a second RF transceiver for communicating with the first RF transceiver of the gateway energy device. At least one expansion energy device is configured to synchronize with the gateway energy device. The synchronization is comprised of receiving instructions to operate or lock the at least one expansion energy device based on the financial account status of the system received by the gateway energy device from the financial account server. The first and second RF transceivers are configured to conserve power by being turned off during certain periods.

The above embodiments are exemplary only. Other embodiments are within the scope of the disclosed subject matter.

### BRIEF DESCRIPTION OF THE DRAWINGS

So that the manner in which the features of the disclosure can be understood, a detailed description may be had by reference to certain embodiments, some of which are illustrated in the accompanying drawings. It is to be noted, however, that the drawings illustrate only certain embodiments and are therefore not to be considered limiting of its scope, for the scope of the disclosed subject matter encompasses other embodiments as well. The drawings are not necessarily to scale, emphasis generally being placed upon illustrating the features of certain embodiments. In the drawings, like numerals are used to indicate like parts throughout the various views.

FIG. 1 is a diagram of an off-grid energy system device, in accordance with one or more aspects set forth herein.

FIG. 2 is a diagram of a system showing a local network of off-grid energy systems and appliances and the flow of information to those devices from a remote data source, in accordance with one or more aspects set forth herein.

FIG. 3 is an electrical block diagram of two off-grid energy storage devices, in accordance with one or more aspects set forth herein.

FIG. 4a is a diagram of one embodiment of a synchronization schedule and process, in accordance with one or more aspects set forth herein.

FIG. 4b is a diagram of another embodiment of a synchronization schedule and process, in accordance with one or more aspects set forth herein.

FIG. 5 is a flow chart of the conditional pairing interaction between a gateway and an expansion device, in accordance with one or more aspects set forth herein.

FIGS. 6a-6b are flow charts of synchronization and data transfer interaction between a gateway and expansion devices, in accordance with one or more aspects set forth herein.

FIG. 7 is a flow chart of different states of an expansion system from factory through normal operation, in accordance with one or more aspects set forth herein.

FIG. 8 is a flow chart of different states of a gateway system from factory through normal operation, in accordance with one or more aspects set forth herein.

FIG. 9 is a diagram showing how a system could be used to communicate wirelessly between a computer or mobile device and an off-grid energy system using an intermediate RF translator, in accordance with one or more aspects set forth herein.

FIG. 10 is a block diagram of a computer system, such as that employed by the devices described herein.

Corresponding reference characters indicate corresponding parts throughout several views. The examples set out herein illustrate several embodiments but should not be construed as limiting in scope in any manner.

### DETAILED DESCRIPTION

The present disclosure relates to an off-grid energy system, and more particularly to an off-grid energy system comprised of multiple devices where the devices are controlled, e.g., through a single financial account. For example, one embodiment of a complete system is comprised of a local network of standalone, off-grid energy systems which communicate with one another using a custom wireless protocol.

By way of example, a network of energy systems may be implemented as follows. Each off-grid energy device may be comprised of the following: 1) an electricity generation device such as a solar panel; 2) a lockable energy storage and distribution device which can accept power from the electricity generator as well as many other electricity sources in order to charge batteries, maintain battery health and safety, and distribute electricity to connected devices; and electronically lock-out (disable) the electrical power outputs from the energy storage system based on internal logic; and 3) devices such as lights, mobile electronics, or appliances which connect to the storage and distribution device to use energy when energy is available. In such a case, each individual energy system is capable of generating, storing, and distributing electricity in isolation. Each system may be further equipped with digital logic which can enable/disable electrical inputs and outputs of that particular energy storage device. Each system may also be equipped with a radio frequency transceiver through which it can communicate with other associated energy systems and devices.

Thus, these techniques represent practical applications that advance the field of off-grid energy systems, by increasing the efficiency of communications among devices. As one advantage, the enhanced communications and coordination techniques set forth herein allow for reduced energy consumption, reduced duplication of components, and increased simplicity of operation.

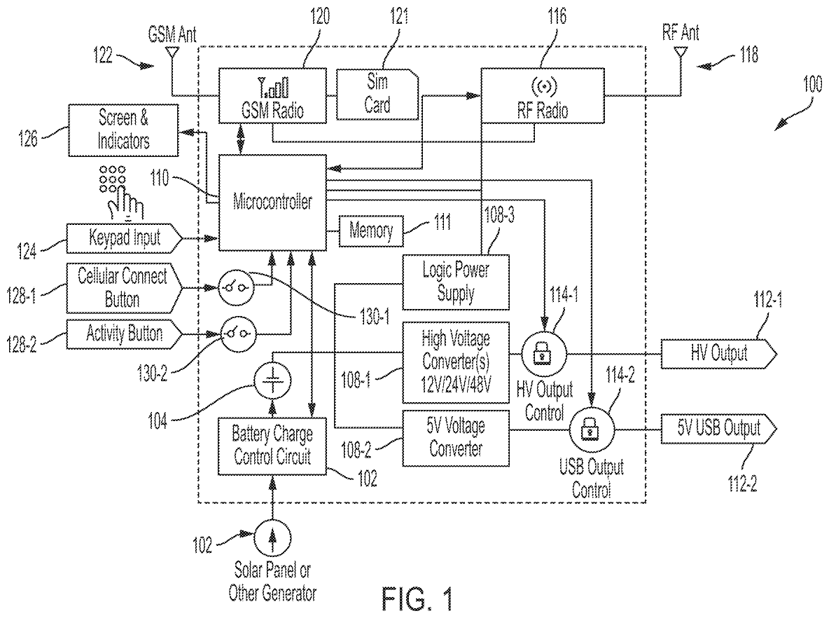

FIG. 1 is a diagram of an off-grid energy system device 100. Each isolated energy system device 100 has its own energy generator 102 such as a solar panel and battery 104 for energy storage. A battery charge control circuit 106 within the device controls safe charging of the battery by the energy generator 102. Voltage converters 108-1, 108-2 within the device convert the battery voltage to output voltage and power aligned to user needs. For instance, high voltage converter 108-1 converts battery voltage to 12V, 24V or 48V, a low voltage converter 108-2 converts battery voltage to 5V, and a logic power supply 108-3 converts battery voltage for use by the device 100.

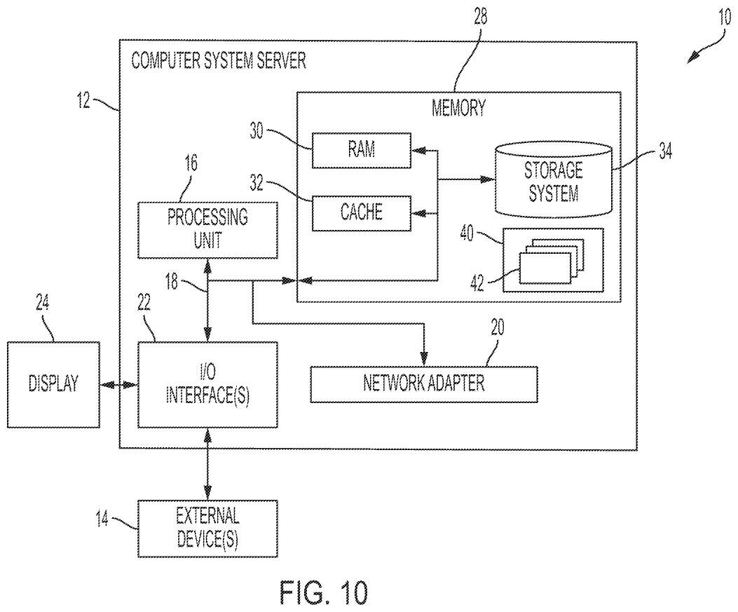

The off-grid energy system device 100 includes a device microcontroller 110, with affiliated memory 111 and other circuitry (see FIG. 10 for further details). The device microcontroller 110 controls access of the device electrical outputs 112-1, 112-2 based on the state of the customer's financial account using output controls 114-1, 114-2. The off-grid energy system device 100 includes an RF transceiver (e.g., a 2.4 GHz RF transceiver) 116 which can be used to communicate between energy system devices on the same network through RF antenna 118. The off-grid energy system device 100 has one or more interfaces for obtaining the state of customer financial account. The account state can be obtained automatically through a cellular network connection to a remote server, or through a numeric code manually entered by the user via a keypad input 124 which is then interpreted by a device-specific decryption key. The cellular network may be accessed by a radio 120 such as a GSM radio, which uses a SIM or other identifying card 121, and communicates remotely using an antenna 122 such as a GSM antenna. The off-grid energy system device also has a basic user interface that includes screens and/or indicator user interface 126 which can provide visual and audio feedback to the user on the battery state-of-charge and device lock/unlock status. The user interface 126 also has two buttons 128-1, 128-2, which the user can use to trigger the device to display its user interface 126, to initiate a cellular connection for device communication with the remote server or to initiate local communications between paired energy systems. For example, cellular connect button 128-1 may initiate a cellular connection via switch 130-1, and activity button 128-2 may trigger the display of user interface 126 via switch 130-2. In addition, power may be locked out from all outputs when not authorized, but energy storage may continue.

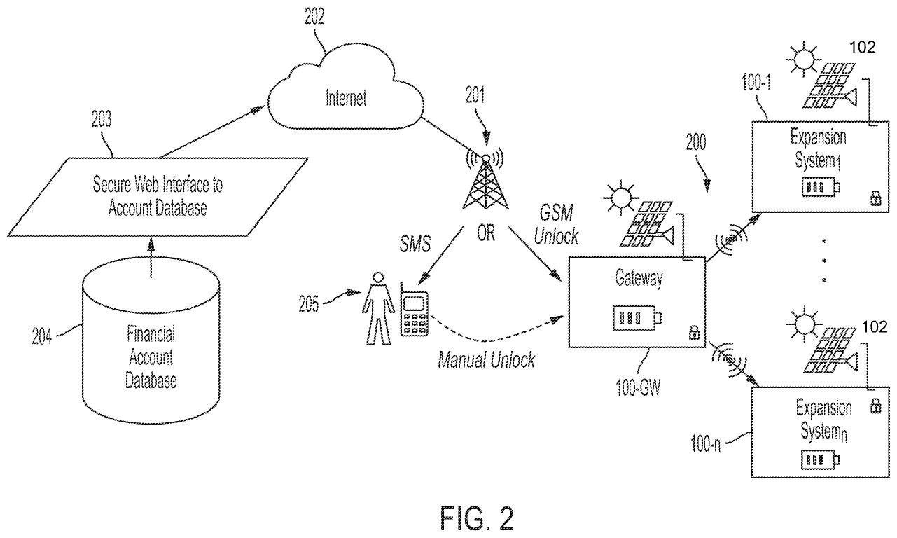

FIG. 2 is a diagram of a system showing a local network 200 of off-grid energy system devices 100-GW, 100-1, 100-n and appliances and the flow of information to those devices from a remote data source. Each of the devices 100-GW, 100-1, 100-n includes features that are the same or similar to device 100 described with respect to FIG. 1. Each off-grid energy system device 100-GW, 100-1, 100-n is able to generate, store, and distribute electricity while also locking or unlocking (enabling or disabling) access to its core functionality. One system in the local network 200 serves as a gateway system device 100-GW. The gateway device 100-GW receives the state of a user's financial account from a financial account database 204 either through cellular communication via cellular network 201 through interne 202 or through a user's device 205 receiving a code and then manually entering the code using the gateway device keypad input 124, as described with respect to FIG. 1. The code, an encrypted 8-digit code unique to the gateway device, contains the number of days of power (lockout interval) based on the status of the financial account. The gateway device uses the days of power to calculate a new lockout interval. For communication over cellular network, the outstanding balance on the financial account is also sent to the device.

The gateway device 100-GW then communicates account status and updated lockout intervals to each of the n system devices it is connected to, e.g., system devices 100-1-100-n in its local network 200. Through this method, a network 200 of isolated off-grid energy systems 100-1-100-n can be associated with a single financial account and controlled through a single gateway 100-GW assuming the systems are in wireless communication proximity.

With respect to operation of the example network of energy systems described above, one device may serve as the financial gateway for all the other systems. This device may be referred to as a gateway or gateway device. In such a case, the state of the gateway device is directly updated with the state of a customer's financial account. In one embodiment, the gateway obtains the customer's account status through one of two mechanisms: 1) communication with a remote server through a cellular or broadband connection, 2) customer manually entering a numeric code into the gateway device which the device then interprets into a financial account state. In such a case, the gateway device may obtain the status of the customer's financial account and then communicates appropriate instructions to all the other energy systems in its network. The customer's account status defines a specific time interval that each system in the network can stay unlocked prior to another customer payment being registered.

Continuing with this example, after obtaining financial account status, the gateway device communicates updated unlock time intervals to all systems with which it is associated. Isolated energy systems that communicate with the gateway device may be referred to as expansion devices or systems. In a situation where all devices in the network are off-grid devices serving the purpose of providing energy to low-income households, the wireless communication link between the gateway and the expansion devices in its network, as set forth herein, advantageously minimizes energy consumption, bandwidth, and cost while also being secure, reliable, and current to the state of the customer's financial account. The gateway and associated systems may communicate through any suitable wireless means (or, if available, a wired means), such as an RF link which may comprise of, but not be limited to the following protocols: Bluetooth Low Energy (BLE), Zigbee, 6LowPAN, LoRa or a custom-built proprietary communications stack based on an ISM band radio.

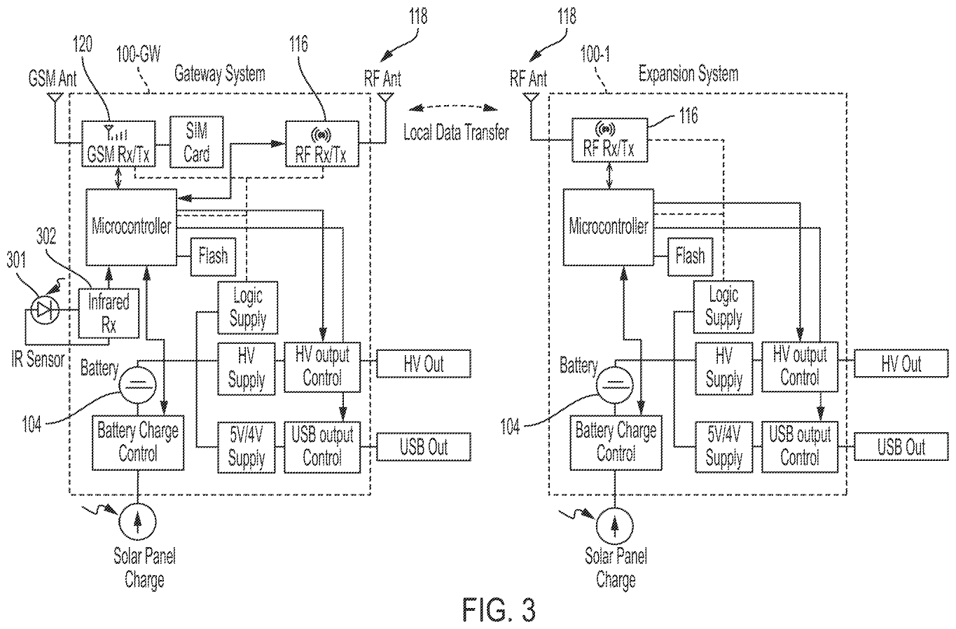

FIG. 3 is an electrical block diagram of two off-grid energy storage devices 100-GW, 100-1. Each device 100-GW, 100-1 contains its own battery 104 which is charged through individually connected solar panels 102. Each device 100-GW, 100-1 provides outputs 112-1, 112-2 for a user to use the battery energy to power 5V USB devices or high-voltage (greater than 5V) devices. Each device contains a microcontroller 110 which is able to control availability of the high-voltage outputs 112-1 or USB outputs 112-2 as well as the ability of the solar panel 102 to charge the battery 104. The gateway device 100-GW contains both a GSM module 120 through which it can transmit and receive data from a remote server, and an infrared receiver 302 through which it can receive a numeric input from a user using an infrared remote control that is detected by an infrared sensor 301. The gateway device 100-GW and the expansion device each contain an RF transceiver 116 which can be used to communicate between the gateway device 100-GW and the expansion device 100-1. The transceiver 116 can be based on a radio supporting protocols including but not limited to the protocols mentioned above within [0029].

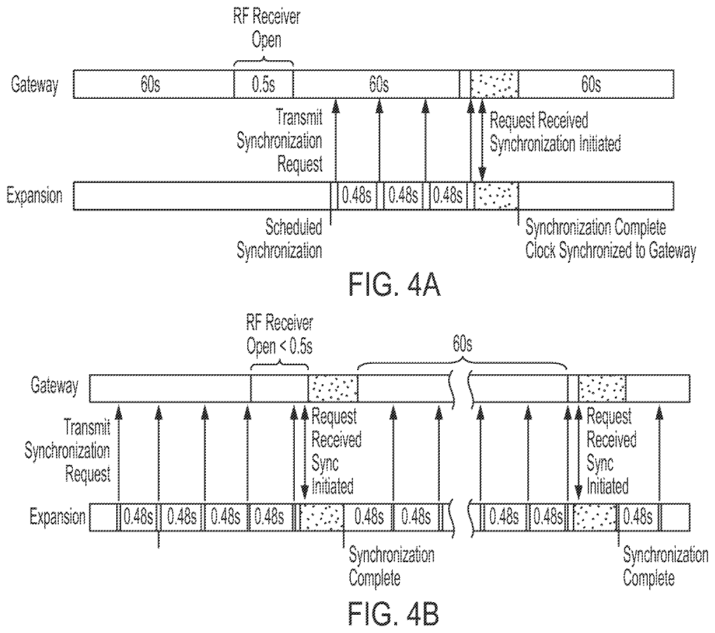

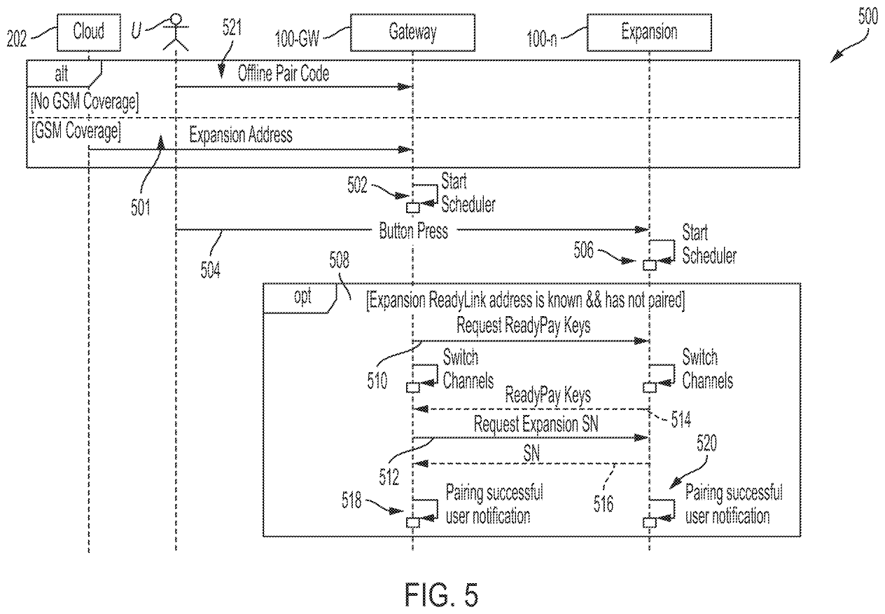

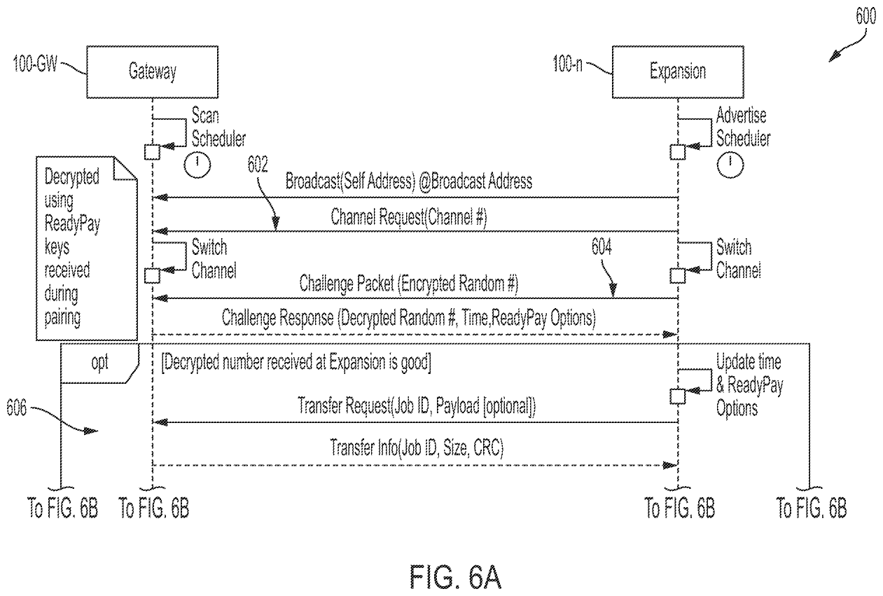

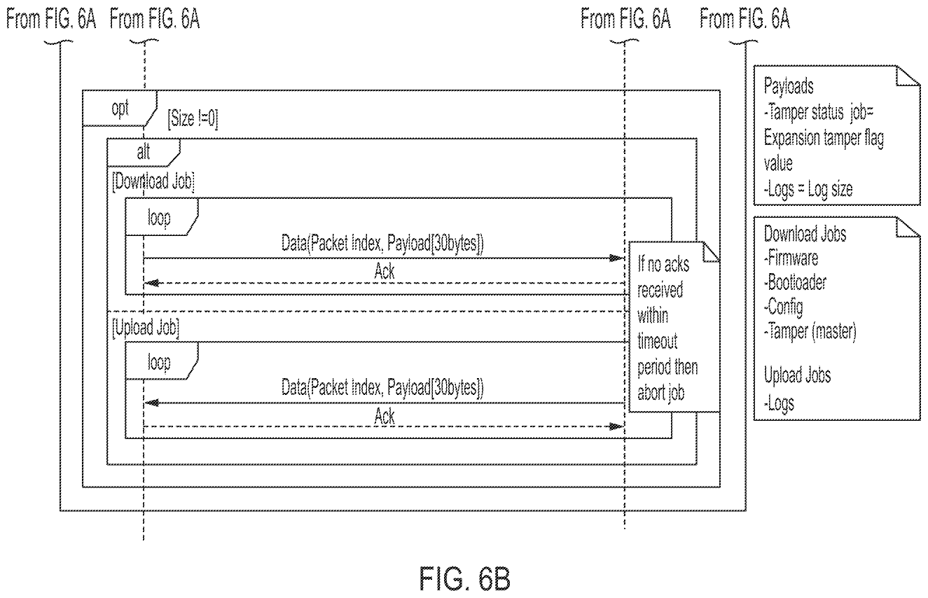

FIG. 4a is a diagram of the synchronization schedule and process such that off-grid devices are able to avoid having an always-on RF receiver or transmitter. In one implementation, periodically, such as with a period of every 60 seconds, the gateway device activates its RF receiver for an interval, such as for an interval of 500 milliseconds. Expansion devices maintain a schedule for when to synchronize with the gateway device within the device firmware. When the expansion device reaches its scheduled synchronization, it begins broadcasting a synchronization request message periodically, such as a period of every 480 milliseconds, until the Gateway System replies. The expansion device broadcasts repeatedly for an interval longer than the period of the gateway device, which is 60 seconds in the example above. These timing values guarantee that the expansion device will send a message during the time window when a gateway device opens its receiver. When the gateway device receives the request and responds, synchronization begins according to the flow described in FIGS. 5 and 6. With each synchronization, the clock on the expansion device is updated to match the clock on the gateway device, which reduces the amount of transmission required for subsequent synchronization. For instance, gateway and expansion devices can periodically sync based on the relative time since the last sync, obviating the need for absolute accuracy of the clocks. As a result of this scheduling method, the gateway device uses the RF interface less than 1% of the time, minimizing energy consumption of the RF transceiver.

To minimize energy consumption, the RF transceivers advantageously remain off until they are communicating, using the techniques of the present disclosure. For instance, in one technique of the present disclosure, both Gateway and expansion devices turn on their RF communication links at the same schedule in order to transfer data and state information, and then return to an off state. In another example, the Gateway and expansion devices may follow different communication schedules. In such a case, the Gateway may scan for 0.5 s every 60 s, whereas the expansion device may perform a synchronization at different intervals, depending on whether the last synchronization was successful or not. For instance, synchronization intervals may be time-aligned by a sliding window in which the expansion devices broadcast at a shorter time interval than the interval at which the gateway device listens. As a further advantage, a scheduling algorithm allows the devices to synchronize and communicate with a worst-case delay of 60 seconds while managing to keep the RF transceiver ON less than 1% of the time until a connection is made.

The gateway device and its associated expansion systems, for instance, use a custom communications protocol for data synchronization. In such a case, the protocol first enables the gateway to confirm it is communicating with a properly associated expansion device. Continuing with this example, following confirmation, the gateway communicates clock synchronization & updated lock time. Thus, this data is uniquely encrypted for each expansion system and is deciphered using a set of pre-programmed keys within each expansion system.

In one embodiment of normal operation, the gateway device and its expansion systems operate in complete isolation. Then, while operating within the unlock time interval, each system generates, stores, and distributes electricity independently. If the customer makes a payment prior to the expiration of that interval, updated lock times are communicated to the gateway and it communicates the updated lock time to individual devices accordingly during its standard synchronization schedule. If the unlock time interval expires prior to a payment, individual systems will lock out their electricity distribution functionality. However, the gateway and the associated systems will continue to communicate according to their synchronization schedules. When a customer makes a payment, the gateway will once again receive an updated unlock time interval and communicate that interval to the appropriate associated systems. The communication with expansion systems will occur automatically as per the synchronization schedule. Alternatively, customers will be able to initiate a manual synchronization between the gateway and an expansion system through a sequence of button presses. If an expansion device is unable to communicate with its gateway device because it is outside of wireless proximity or because of a technical fault, the expansion device continues to operate normally until the device's most recent unlock time interval expires at which point it will lock until communication with a gateway is re-established an updated lock time is communicated.

The system also envisions a method by which new expansion devices are associated with the gateway. The association process is unique since it cannot rely on standard association protocols available to 802.11X and Bluetooth devices as they typically require complex user interaction to perform the association. The system implements a unique association method to allow a gateway device to discover new systems for association. In this method, the gateway device receives a new configuration file from the remote server. The updated configuration file includes the device identification tag and account information for a newly purchased system. The gateway and the new system are placed within wireless proximity and both devices are placed in “pairing mode” through a sequence of button presses on each individual device. In “pairing mode”, the newly associated system broadcasts its unique device identification code according to a specific coded format. The gateway device turns on its RF receiver and listens for device codes that match the new code in its configuration file. Once the gateway discovers the newly associated system, it executes a standard synchronization according to the synchronization protocol, during which the encryption keys are exchanged to secure future communications. This association can also occur without user interaction - as long as the gateway device obtains the configuration file it will eventually pair with the expansion device thanks to the synchronization schedule.

FIG. 4b is another synchronization scheduling method between gateway and expansion devices such that both off-grid devices maintain more regular synchronization in a method that avoids having an always-on RF receiver or transmitter. In one specific example, every 60 seconds, the gateway device activates its RF receiver for 500 milliseconds. Expansion devices broadcast a short synchronization request message every 480 milliseconds, retrying a specified number of times. When broadcasting a message, the expansion device only turns on its RF radio for a few milliseconds. These timing values guarantee that the expansion device will send a message during a time window when a gateway device has activated its receiver. The timing values can be modified to achieve the same result as long as overlap of the transmission and receiver are achieved. When the gateway device receives the request and responds, synchronization begins according to the flow described in FIGS. 5 and 6. This method takes advantage of the short duration an expansion device needs to turn on its radio in order to broadcast a synchronization request in order to achieve more regular synchronization between gateway and expansion and to avoid any requirement for clock synchronization.

FIG. 5 is a flow chart of the conditional pairing interaction 500 between the gateway device 100-GW and the expansion device 100-n in situations where the gateway device 100-GW has a cellular connection to a remote server via cloud 202 and situations where the gateway device does not have a connection to a remote server via cloud 202. If the gateway device 100-GW has cellular connectivity, a press of the Cellular Connect button 128-1 (see FIG. 1) on the gateway device 100-GW triggers the device 100-GW to download its latest configuration, at step 501, which includes a list of expansion devices, such as expansion device 100-n, which are part of the financial account. The gateway device 100-GW then at step 502 starts its scheduler where it listens for expansion devices identifying as one of the expansion devices listed within the gateway's configuration. Pressing the Activity button 128-2 (see FIG. 1) at step 504 on the expansion devices launches its scheduler at step 506 where it broadcasts its identifying information. When the gateway device recognizes the new expansion device's identifying address by referring to its configuration file in step 508, it initiates the pairing process. The gateway device requests the unique payment key programmed within the expansion device at the time of manufacture at step 510 as well as the expansion device serial number at step 512. At steps 514, 516, the expansion device responds with its key and serial number. Once both are received, pairing is successful and both devices communicate to the user a successful pairing through their user interface at steps 518, 520.

In the situation where a gateway device does not have a cellular connection to a remote server from which it can download pairing codes, the pairing process can be initiated by the user U manually entering a pairing code, at step 521, for a specific expansion device into the gateway device using the gateway device's keypad. The pairing code uniquely identifies the new expansion system which is to be associated with the Gateway. Once entered, the remainder of the discovery and pairing process begin as described above.

FIGS. 6a-6b are flow charts of the synchronization and data exchange interaction 600 between the gateway 100-GW and the uniquely paired expansion devices, such as device 100-n, that are under its control. Gateway device 100-GW scans for devices and expansion devices 100-n broadcast according to the synchronization schedule method described in FIG. 4. Although a single gateway and a single expansion device are depicted, multiple gateways and multiple expansion devices may be part of the system and would each communicate in a same or similar manner. When the gateway device 100-GW receives a signal from a recognized expansion device 100-n, it transmits a challenge packet request at step 602 to ensure the expansion device is authentic. The expansion device responds with a challenge packet at step 604 which the gateway device interprets using the unique payment key received during pairing and sends the interpreted data back to the expansion device (described in FIG. 5). If the expansion device receives the correct interpretation of the data it initially sent in the challenge response, then synchronization begins at step 606. The Gateway device transmits updated time, a configuration file which includes the financial account state and synchronization schedule, and updated firmware and bootloader binary packages if available. The time, configuration files and firmware binary packages on the gateway device are downloaded from the remote server during the gateway's cloud sync interval. A single firmware binary package holds the firmware for all potential gateway and expansion devices. After receiving data from the gateway device, the expansion device transmits its log data back to the gateway device. The gateway device then transmits log data for itself and all paired expansion devices back to the remote central server. In this manner, historical data and the current state of all gateway devices and expansion devices is made accessible to customer service professionals for monitoring reliability, analyzing usage and degradation, and resolving technical issues.

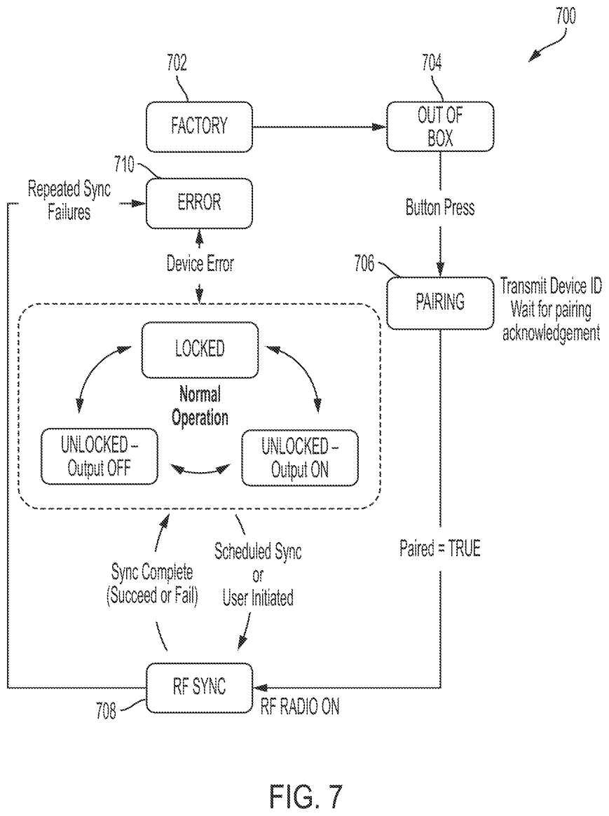

FIG. 7 is a flow chart of the different state changes 700 of an expansion system from factory through to normal operation. An expansion device 100-n will leave the factory at step 702 unpaired to a specific gateway device 100-GW. Following sale, the expansion device 100-n is un-boxed, and a button pressed at step 704. Next, at step 706, pairing will be initiated where a gateway device 100-GW will discover an expansion device within its network range. Once paired, an expansion device will regularly synchronize at step 708 to its gateway according to the synchronization method described in FIGS. 4a, 4b, 5, and 6. During synchronization at step 708, the expansion device will 1) synchronize its internal clock to the gateway device clock, 2) receive updated financial account status from the gateway as well as firmware and bootloader binary files if available, and 3) upload log data to the gateway. Repeated synchronization failures will result in both the gateway device and the expansion device showing an error at step 710.

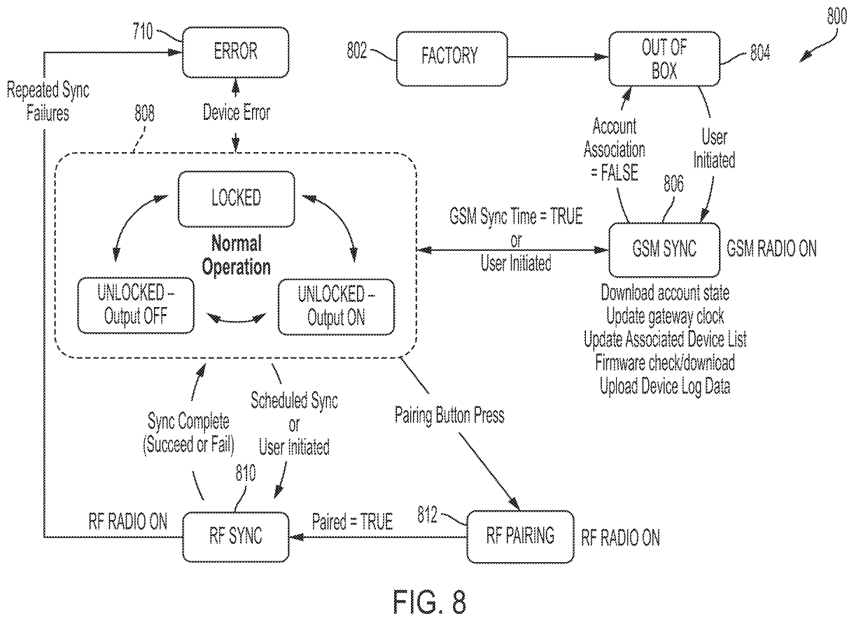

FIG. 8 is a flow chart of the different state changes 800 of a gateway system from factory through to normal operation. A gateway device will leave the factory at step 802 with no connection to a customer financial account. When activated, the device will operate in an out-of-box demonstration mode at step 804. The gateway device will be associated with a customer account either through a user-initiated GSM synchronization to the remote server at step 806 or when the user enters a code through the manual keypad. Once the gateway device is associated with a customer account, it will enter normal operation at step 808. In normal operation, the gateway system functions as its own standalone, off-grid energy system based on the state of the customer's account. The gateway system updates account state and device configurations through its cellular connection which happens at set intervals or when a user presses the cellular connect button to initiate a synchronization at step 806. Updated configuration files received from the server contain a list of pairing codes for all expansion systems with which the gateway system should accept communication. The gateway system synchronizes data with expansion systems in its own network according to the synchronization method described in FIGS. 4a, 4b, 5, and 6.

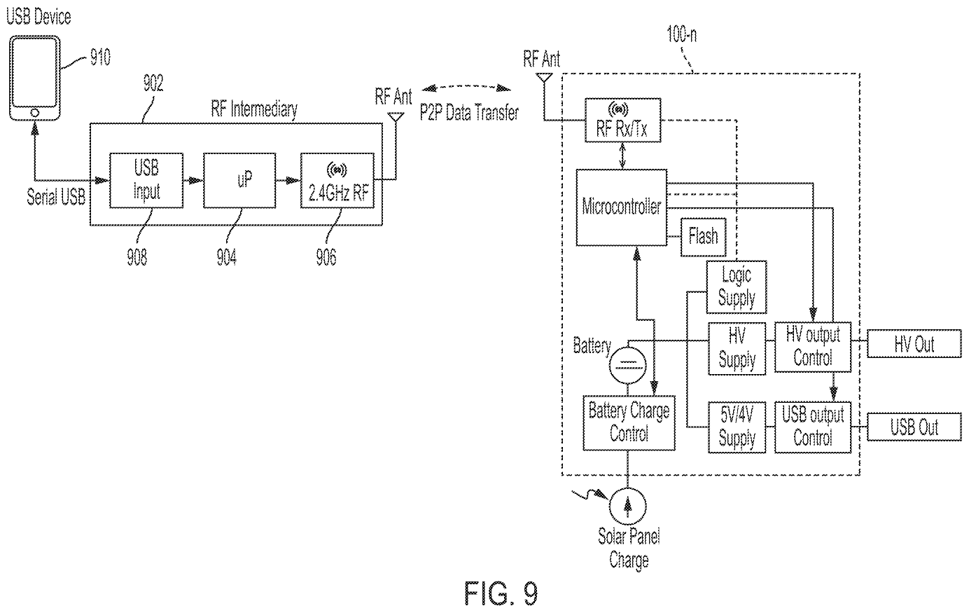

FIG. 9 is a diagram showing how the same system 100-n could be used to communicate wirelessly between a computer or mobile device and an off-grid energy system using an intermediary RF translator 902. The RF translator 902 includes a microprocessor 904, RF transceiver 906, and a USB input 908. The RF translator 902 will receive serial USB communication and USB power from the computer or mobile device 904 via the USB input 908. An application executing on the computer or mobile device 910 will send commands to the RF translator 902 which will then translate the commands into an RF signal to send to the off-grid energy system using the same peer-to-peer protocol that gateway and expansion systems use to communicate with one another via RF transceiver 906. For example, the RF translator could embody the techniques set forth herein, and could be used to retrofit a fielded energy storage device to act as a gateway device according to the present disclosure.

By way of summary, certain example embodiments of the present disclosure are now set forth. For instance, in one embodiment, is a local wireless network of independent, digitally lockable off-grid energy systems controlled by a single financial account, where one system serves as a gateway for receiving the status of the financial account and controls the lock status of other systems in its network by communicating the account status to off-grid energy systems in its network through the local wireless link.

In another embodiment, described herein is an off-grid energy system which operates as a financial control gateway and is comprised of an electricity generator, energy storage system, and energy distribution controller which can receive state updates on a remote financial account through a cellular link or manual user input, enable or disable its own functionality based on the state of the financial account, and correspondingly communicate the financial account state to uniquely paired off-grid energy systems or devices through a wireless protocol.

In another embodiment, described herein is a method for synchronizing wireless communication between off-grid energy devices in a local RF network that minimizes aggregate energy consumption by not requiring an always on radio receiver or transmitter.

In another embodiment, described herein is a method for establishing a local wireless link between an off-grid energy system designated as a gateway device and a uniquely specified set of expansion devices when the gateway device has an established connection to a remote server via a cellular connection but the expansion devices do not.

In another embodiment, described herein is a method for establishing a wireless link between an off-grid energy system designated as a gateway device and a uniquely specified expansion device when all devices are unable to communicate with a remote server.

In another embodiment, described herein is a method for wirelessly updating the firmware and bootloader of individual off-grid energy systems by transmitting a firmware binary package from a remote server to a gateway system via a cellular network, and the gateway system re-transmitting the binary package for communication through a local RF protocol.

In another embodiment, described herein is a method for remotely monitoring expansion devices in a local wireless network of off-grid energy devices by having individual expansion devices upload their log data to a gateway device and the gateway device packaging and uploading log data for all devices in its network to a remote server via a cellular connection.

In another embodiment, described herein is an apparatus and method for using a mobile phone or PC and an intermediary RF translator device to wirelessly communicate with an off-grid energy device, and where the mobile phone or PC provides a user interface for diagnosing and controlling the device.

FIG. 10 is a block diagram of a computer system 10, such as that employed by the system 100-GW, 100-1, 100-n of FIG. 1, or by any other computerized system described herein. A computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed environments where tasks are performed by remote processing devices that are linked through a communications network. In a distributed environment, program modules may be located in both local and remote computer system storage media including memory storage devices.

Computer system/server 12 in computer system 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/ Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to microcode, device drivers, redundant processing units, external disk drive arrays, RAID systems, tape drives, and data archival storage systems, etc.

Embodiments may include a system, a method, and/or a computer program product. The computer program product may include a computer readable storage medium (or media) having computer readable program instructions thereon for causing a processor to carry out aspects of set forth herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the certain embodiments may be assembler instructions, instruction-set-architecture (ISA) instructions, machine instructions, machine dependent instructions, microcode, firmware instructions, state setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects set forth herein.

Embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for controlling an off-grid energy system comprising a gateway energy device and an expansion energy device, the gateway energy device comprising a first energy source, a first battery for storing energy from the first energy source, a first power output for outputting energy from the first battery, a first output lock for controlling the first power output, and a first radiofrequency (RF) transceiver, and the expansion energy device comprising a second energy source, a second battery for storing energy from the second energy source, a second power output for outputting energy from the second battery, a second output lock for controlling the second power output, and a second RF transceiver for communicating with the first RF transceiver of the gateway energy device, and the method comprising:
receiving a financial account status of the system from a financial account server;
locking or unlocking the first power output of the gateway energy device responsive to the received financial account status;
connecting with the at least one expansion energy device;
sending instructions to operate or lock the at least one expansion energy device based on the received financial account status of the system;
locking or unlocking the second power output of the at least one expansion energy device responsive to the received financial account status; and
conserving power by limiting communications with the at least one expansion energy device during certain periods.

2. The method of claim 1, wherein the method comprises connecting with multiple expansion energy devices and sending instructions for operation or locking the multiple expansion energy devices based on the received financial account status of the system.

3. The method of claim 1, further comprising periodically listening for the at least one expansion energy device during first time intervals and receiving intermittent transmissions from the at least one expansion energy device during second time intervals, and overlapping partially the first and second time intervals to eliminate the need for synchronization and to reduce constant communication between the energy devices.

4. The method of claim 1, further comprising adjusting clocks or schedules to facilitate future communications without constant communication between the energy devices.

5. The method of claim 1, further comprising pairing with the at least one expansion energy device.

6. The method of claim 1, further comprising receiving the financial account status of the system manually from a user.

7. The method of claim 1, further comprising using a wireless network transceiver for communicating with the financial account server to receive the financial status information.

8. The method of claim 1, further comprising communicating with the financial account server by transmitting and receiving RF signals to and from an RF intermediator device, wherein the RF intermediator device transmits and receives the RF signals from to and from the financial account server using the wireless network transceiver.

9. An off-grid energy system comprising:
a gateway energy device, the gateway energy device comprising a first energy source, a first battery for storing energy from the first energy source, a first power output for outputting energy from the first battery, a first output lock for controlling the first power output, and a first radio frequency (RF) transceiver, wherein the gateway energy device is configured to receive a financial account status of the system from a financial account server, wherein responsive to the received financial account status, the first output lock is locked or unlocked; and
at least one expansion energy device, the at least one expansion energy device comprising a second energy source, a second battery for storing energy from the second energy source, a second power output for outputting energy from the second battery, a second output lock for controlling the second power output, and a second RF transceiver for communicating with the first RF transceiver of the gateway energy device, wherein the least one expansion energy device is configured to synchronize with the gateway energy device, the synchronizing comprising receiving instructions to lock or unlock the second output lock of the at least one expansion energy device based on the financial account status of the system received by the gateway energy device from the financial account server, wherein the first and second RF transceivers are configured to conserve power by being turned off during certain periods.

10. The off-grid energy system of claim 9, wherein the at least one expansion energy device comprises multiple expansion energy devices, and each of the multiple expansion energy devices synchronizes with the gateway energy device to receive instructions for operation or locking based on the financial account status of the system received by the gateway energy device from the financial account server.

11. The off-grid energy system of claim 9, wherein the synchronizing comprises the first RF transceiver periodically listening for the second RF transceiver during first time intervals, and the second RF transceiver transmitting intermittently to the first RF transceiver during second time intervals, wherein the second time intervals overlap partially with the first time intervals to facilitate the first RF transceiver communicating with the second RF transceiver without the RF transceivers being constantly turned on.

12. The off-grid energy system of claim 11, wherein the synchronizing comprises the first and second RF transceivers adjusting clocks or schedules to facilitate future communications without the RF transceivers being constantly turned on.

13. The off-grid energy system of claim 9, wherein the synchronizing further comprises pairing with the gateway energy device.

14. The off-grid energy system of claim 9, wherein the gateway energy device further comprises a user interface for receiving the financial account status of the system manually from a user.

15. The off-grid energy system of claim 9, wherein the gateway energy device comprises a wireless network transceiver for communicating with the financial account server to receive the financial status information.

16. The off-grid energy system of claim 9, further comprising an RF intermediator device, the RF intermediator device comprising a third RF transceiver and a wireless network transceiver, wherein the gateway energy device communicates with the financial account server by transmitting and receiving RF signals to and from the RF intermediator device, and the RF intermediator device transmits and receives the RF signals from to and from the financial account server using the wireless network transceiver.
